(19) United States
(12) Patent Application Publication
(10) Pub. No.: US 2008/0188629 A1
(43) Pub. Date: Aug. 7, 2008

(54) POLY-L-LACTIC ACID CRYSTALLIZATION ACCELERATOR AND PRODUCTION METHOD THEREOF

(75) Inventor: Toru YANO, Hiroshima-shi (JP)

Correspondence Address: SUGHRUE-265550, 2100 PENNSYLVANIA AVE. NW, WASHINGTON, DC, 20037-3213, US

(73) Assignee: NISHIKAWA RUBBER CO., LTD., Hiroshima-shi (JP)

(21) Appl. No.: 11/958,922

(22) Filed: Dec. 18, 2007

(30) Foreign Application Priority Data
Feb. 5, 2007 (JP) 2007-025761

(51) Int. Cl. C08G 63/08

(52) U.S. Cl. 525/451

(57) ABSTRACT

By using a copolymer of a composing unit (A) having a hydrophilic polar group in the molecule with a composing unit (B) having high compatibility with poly-L-lactic acid as a crystallization accelerator, crystallization of poly-L-lactic acid is accelerated and its heat resistance is improved.

### BACKGROUND OF THE INVENTION

1. Field of the Invention

A feature of the present invention relates to a polylactic acid crystallization accelerator which accelerates crystallization rate of poly-L-lactic acid (PLLA).

2. Brief Description of the Background Art

Since polylactic acid is excellent in transparency, rigidity, heat resistance, workability and the like in comparison with other biodegradable resins, it is drawing attention as a substitution material for ABS, polyester and the like (Patent References 1 and 2).

However, although polylactic acid has higher heat stability among biodegradable resins, it does not have a heat stability which can withstand its practical use in comparison with ABS, polyester and the like. In general, heat resistance at a temperature of from 50 to 70° C. for indoor use, or of 90° C. for mounting use on automobiles and the like, is required. When safety at the time of use is taken into consideration, durability for an atmospheric temperature of 100° C. is required. However, although polylactic acid is generally a crystalline resin, its crystallization rate is slow; its crystallinity is not high in the case of general moldings; and its heat resistance is around 60° C.

Additionally, although polylactic acid has a crystalline property and its heat resistance exceeds 60° C. by its crystallization, the crystallization rate thereof is slow. Thus, a molding method which is different from the case of general resins, such as the necessity for a post-crystallization step, is required, which results in high cost.

Improvements of the crystallization rate of polylactic acid and further of heat resistance have been carried out in various way. Particularly, improvement of crystallization rate using a stereo complex of polylactic acid is well known. Since lactic acid which constitutes polylactic acid has an asymmetric carbon, D-lactic acid and L-lactic acid are present as optical isomers. Since a strong interaction occurs between poly-D-lactic acid having only D-lactic acid as the composing component and poly-L-lactic acid having only L-lactic acid as the composing component, melting point is increased and the stereo complex is formed when both of them are blended. Patent Reference 3 describes that when poly-L-lactic acid and poly-D-lactic acid having specified molecular weights are melted and mixed, formation of their stereo complex is accelerated and a polylactic acid resin composition having a good moldability is obtained. However, even by such a method, formation rate of the stereo complex was not sufficient and a polylactic acid resin composition having excellent heat resistance was not able to obtain.

Additionally, Patent Reference 4 describes a resin composition which comprises a polylactic acid resin and a polyacetal resin and has excellent crystallization characteristic and heat resistance. However, polyacetal has a disadvantage in that it is degraded and generates a bad smell when blended with polylactic acid, since it is sensitive to acid.

[Patent Reference 1] JP-A-04-220456

[Patent Reference 2] JP-A-08-193165

[Patent Reference 3] JP-A-2003-096285

[Patent Reference 4] JP-A-2003-253106

### SUMMARY OF THE INVENTION

The object of the present invention is providing a poly-L-lactic acid crystallization accelerator which substantially increases heat resistance of poly-L-lactic acid, by stabilizing crystalline property through the acceleration of crystallization of poly-L-lactic acid.

With the aim of resolving the aforementioned problems, the inventors of the present application have conducted intensive studies and found as a result that a copolymer of a composing unit (A) having a hydrophilic polar group in a molecule with a composing unit (B) having high compatibility with poly-L-lactic acid accelerates crystallization of poly-L-lactic acid and improves heat resistance to accomplish the present invention.

That is, the invention is described as follows.

[1] A crystallization accelerator of poly-L-lactic acid, in which a composing unit (A) having a hydrophilic polar group in a molecule and a composing unit (B) having high compatibility with poly-L-lactic acid are copolymerized.

[2] The crystallization accelerator according to [1], in which the composing unit (A) and composing unit (B) are copolymerized at a ratio of from 0.1:99.9 to 80:20 (mass ratio).

[3] The crystallization accelerator according to [1] or [2], in which a molecule of composing unit (A) comprises two or more of hydrophilic polar groups.

[4] The crystallization accelerator according to any one of [1] to [3], in which the hydrophilic polar group is at least one of hydroxyl and/or carboxyl.

[5] The crystallization accelerator according to [4], in which the composing unit (A) is at least one of monosaccharides, polysaccharides and aromatic ring compounds.

[6] The crystallization accelerator according to [5], in which the composing unit (A) is at least one of glucose, starch, amylopectin, amylose, pyromellitic acid and pyrogallol.

[7] The crystallization accelerator according to any one of [1] to [6], in which the composing unit (B) is at least one of monomers of poly-L-lactic acid and poly-D-lactic acid and a PLLA-aliphatic polyester block copolymer and a PDLA-aliphatic polyester block copolymer.

[8] A resin composition, in which from 0.5 to 50 parts by weight of the crystallization accelerator described in any one of [1] to [7] is blended per 100 parts by weight of poly-L-lactic acid.

[9] A molded product prepared by molding the resin composition described in [8].

[10] A method for producing a resin composition which contains poly-L-lactic acid, which comprises the following (1) and (2):

(1) synthesizing a poly-L-lactic acid crystallization accelerator by copolymerizing a composing unit (A) having a hydrophilic polar group in the molecule and a composing unit (B) having high compatibility with poly-L-lactic acid, and

(2) mixing the poly-L-lactic acid crystallization accelerator synthesized in the step (1) with poly-L-lactic acid.

### BRIEF DESCRIPTION OF THE DRAWINGS

FIG. 1 is a schematic illustration showing structures of the crystallization accelerator of the present invention.

### DETAILED DESCRIPTION OF THE INVENTION

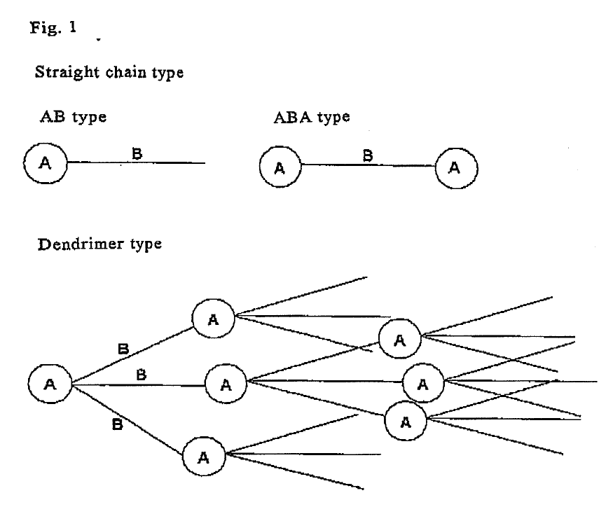

The crystallization accelerator of the present invention comprises a composing unit (A) having a hydrophilic polar group in a molecule and a composing unit (B) having high compatibility with poly-L-lactic acid which are copolymerized. As shown in FIG. 1) it may be straight chain form such as AB type, ABA type and BAB type or a dendriform dendrimer type as an assembly thereof. Ratio (mass ratio) of the composing unit (A) and composing unit (B) in the crystallization accelerator is preferably within the range of from 0.01:99.99 to 90:10, more preferably within the range of from 0.1 to 99.9 to 5:95, since crystallization can be accelerated by setting it within the range.

The composing unit (A) has a hydrophilic polar group in its molecule. The number of hydrophilic polar group(s) in the molecule is 1 or more, more preferably from 2 or more, particularly preferably from 2 to 10, since formation of a stereo complex with poly-L-lactic acid can be accelerated when hydrophilic polar groups are present in a high density in the molecule of composing unit (A). Although the hydrophilic polar group is not particularly limited as long as it has reactivity with the composing unit (B) which is described later, examples of it include hydroxyl, carboxyl, amino and alkoxyl. When two or more polar groups are present in the molecule of composing unit (A), the polar groups may be a single substance or a combination of two or more species.

Specific examples of the composing unit (A) include monosaccharides, polysaccharides, aromatic ring compounds and the like having hydroxyl. Examples of the monosaccharides include glucose, mannose, galactose, fructose and the like. Examples of the polysaccharides include starch (amylopectin and amylose), chitin, cellulose, chitosan, chitin chitosan, glucomannan and the like. Examples of the raw material plant of starch include potato, wheat, corn, sweet potato, rice, cassava, arrowroot, dogtooth violet, green gram and the like. Examples of the aromatic ring compounds include pyrogallol, pyromellitic acid, p-aminobenzoic acid, catechol, salicylic acid and the like.

Although specific examples of the composing unit (A) also include pyromellitic acid and an anhydride thereof, an acetophenone derivative having a functional group, an aniline derivative having a functional group, a benzoic acid derivative having a functional group, a phenol derivative having a functional group, a naphthalene derivative having a functional group, a cyclohexane derivative having a functional group and the like, they are not limited thereto. Examples of the functional group include carboxyl, hydroxyl, amino, acetyl, sulfonate, nitrile, mercapto and the like.

Examples of the aforementioned acetophenone derivative include eugenol acetate and p-methylacetophenone. Examples of the aforementioned aniline derivative include acetoacetic anilide, p-aminobenzoic acid, 2-aminothiophenol, aminophenol and the like. Examples of the aforementioned phenol derivative include phloroglucinol, metol, resorcin, amidol and the like. Examples of the aforementioned naphthalene derivative includes β-oxynaphthoic acid, (R)-1,1′-bi-naphthol, (S)-1,1′-bi-naphthol, quinaldinic acid and the like. Examples of the aforementioned cyclohexane derivative include cyclohexanoldimethylacetal, dicyclohexylamine, dicyclohexylcarbodiamide, N-carboxy-4,4′-methylenebiscyclohexylamine and the like.

Although the composing unit (B) is not particularly limited as long as it is a polymer or oligomer having high compatibility with poly-L-lactic acid, but for example, poly-L-lactic acid (PLLA) single monomer and poly-D-lactic acid (PDLA) single monomer and a PLLA-aliphatic polyester block copolymer, a PDLA-aliphatic polyester block copolymer, a PLLA-aliphatic polyester-PDLA block copolymer and the like are preferable. Examples of the aliphatic polyester moiety include polyurethane, polyether, polyamide and the like.

The composing unit (A) and composing unit (B) can be copolymerized by using various conventionally known polymerization methods. For example, condensation reactions such as dehydration reaction, and de-alcohol reaction, metals such as alkoxy titanium and crosslinking agents such as silane coupling agent and hexamethylene diisocyanate can be used. When the number of production steps and raw material cost are taken into consideration, it is particularly preferable to synthesize it by a non-solvent direct polymerization method. Namely, it can be synthesized by charging the aforementioned respective reaction components into a reaction vessel, adding a reaction catalyst thereto and stirring the contents with heating under a reduced pressure to carry out the reaction.

Although the reaction catalyst to be used in the copolymerization of the composing unit (A) and composing unit (B) may be any catalyst which is used in general polyester polymerization, since there is a case in which the raw material lactic acid contains a large amount of water, a catalyst which has excellent hydrolysis resistance and catalytic activity is preferable. Although such a catalyst include organic metal compounds such as monobutyltin oxide and 1,3-substituted tetraalkyldistannoxane, inorganic compounds such as tin octylate and metallic tin powder and organic compounds such as polyesterase enzymes, it is not limited thereto. Among them, monobutyltin oxide is particularly preferable because of its high hydrolysis stability.

It is preferable weight mean molecular weight of the crystallization accelerator of the present invention obtained in this manner is set within the range of from 1,000 to 10,000,000, since crystallization of poly-L-lactic acid is accelerated and its heat resistance and mechanical strength are further improved when weight average molecular weight of the crystallization accelerator is set to be 1,000 or more. This is also because excessive increase in the melt viscosity of poly-L-lactic acid can be suppressed and uniform dispersion of respective raw materials can be achieved when weight the average molecular weight is set to be 10,000,000 or less.

The resin composition of the present invention obtained by blending poly-L-lactic acid with the crystallization accelerator of the present invention can easily effect regulation of biodegradation rate and melt viscosity. For example, regulation of biodegradation rate can be carried out by increasing adding amounts of starch, polyatomic alcohol and polyatomic carboxylic acid of the copolymer substances, and regulation of melt viscosity can be carried out by increasing adding amount of starch. It is preferable that from 0.5 to 20 parts by weight of the crystallization accelerator of the present invention is blended per 100 parts by weight of poly-L-lactic acid (PLLA).

Additionally, the resin composition of the present invention has an improved crystallization rate. Namely, its crystallization rate is increased. Because of this, crystallization of the composition is quickly completed during its fabrication process and thermal deformation of the molded product is sharply suppressed. In general, a polylactic acid system resin is a resin which has a glass transition point (Tg) of from 50 to 60° C., a crystallization temperature of from 100 to 120° C. and a melting point of from 160 to 180° C. Therefore, a molded product of the polylactic acid system resin is softened and deformed when it is left at a temperature of its glass transition point or more. However, a molded product in which its crystallization is sufficiently progressed is not thermally deformed until its melting point. According to the resin composition of the present invention, it is considered that the crystallization accelerator forms an eutectic crystal having a melting pint of about 200° C. by the heat at the time of molding due to the blending of the crystallization accelerator and it becomes the nucleus agent of crystallization and achieves quick crystallization.

As occasion demands, various inorganic fillers such as fumed silica, wet silica, carbon black, talc, mica, clay, alumina, calcium carbonate and black lead may be added to the resin composition of the present invention with the aim of improving fabrication property, resin strength, fire retardancy, durability and the like. Also, plant oil system softening agent such as fatty acid, soybean oil, rapeseed oil and rosin, cellulose powder, fibers, natural rubber, polycarbodiimide, factice and the like may be added thereto with the aim of improving impact resistance and durability. Additionally, inorganic foaming agent such as sodium bicarbonate, ammonium bicarbonate, sodium carbonate and ammonium carbonates and organic foaming agents such as azodicarbonamide and p,p′-oxybisbenzenesulfonylhydrazide may be added thereto with the aim of effecting foaming.

The molded product of the present invention is obtained by injection-molding the aforementioned resin composition in a desired shape of heated mold. Conditions of the injection molding are not particularly limited and may be appropriately decided by taking composition, molecular weight and blending ratio of the crystallization accelerator, kinds of additive agents and the like into consideration. Example of the conditions include a cylinder temperature of from 160 to 180° C., an injection pressure of from 45 to 70 kg/cm², an injection time of from 0.5 to 10 seconds, a nozzle temperature of from 175 to 185° C. and the like.

Additionally, it is preferable to set heating temperature of the mold within the range of from 90 to 130° C., since heat resistance of the obtained molded product can be further improved (e.g., increase in the thermal deformation temperature) when the mold temperature is set to be 90° C. or more. This is also because hardening time of the aforementioned resin composition can be shortened and the production cost can therefore be suppressed. In this connection, it is preferable to set holding time (cooling time) of the thus injection-molded biodegradable resin moldings in the mold within the range of from 60 to 180 seconds, since its heat resistance is improved by setting to the range.

Specific examples of the molded product of the present invention include resin parts for automobile and the like such as bumpers, instrument panels and door trims, resin parts for electric appliances such as various bodies of equipment, resin parts for agricultural materials and agricultural machines such as containers and culture vessels, resin parts for aquacultural businesses such as floats and containers of aquacultural processed goods, tableware and food containers such as dishes, cups and spoons, resin parts for medical treatment such as injectors and intravenous drip injection containers, resin parts for dwelling, public works and building material such as drain materials, fences, doghouses, electric panels for construction work and the like, and resin parts for leisure and general merchandise such as cooler boxes, fans and toys. Additionally, it can also be made into extrusion moldings such as films, sheets and pipes, blow moldings and the like.

According to the crystallization accelerator of the present invention, handling in view of production can be improved, for example, achievement of shortening of take out time of a product at the time of molding, by quickening crystallization rate of poly-L-lactic acid. Therefore, a resin composition which has improved heat resistance due to crystallization of poly-L-lactic acid and excellent handling ability at the time of molding, and a molded product, which have excellent heat resistance and also can regulate biodegradation rate and melt viscosity can be obtained.

### EXAMPLES

### Synthesis of Crystallization Accelerator

Into a 500 ml capacity separable flask equipped with an external stirrer and an air cooler, 200 g of 90% D-lactic acid, 0.6 g of corn-derived starch and 0.1 g of monobutyltin oxide were put and stirred for 22 hours with heating at a reaction temperature of 190° C. under a degree of vacuum of 15 Torr using a vacuum pump and an oil bath. Yield of the thus obtained crystallization accelerator 1 was 88%. Other crystallization accelerators 2 to 8 were also synthesized by the same method. Compositions and yields of the crystallization accelerators 1 to 8 are shown in Table 1.

### Preparation of Resin Compositions

A resin composition I was obtained by weighing 100 parts by weight of poly-L-lactic acid (Mitsui Chemicals, LACEA H-100J), 20 parts by weight of a polylactic acid-aliphatic polyester block copolymer (DAINIPPON INK AND CHEMICALS INC., PLAMATE PD-150), 5 parts by weight of polycaprolactone (DAICEL CHEMICAL INDUSTRIES, LTD. PLACCEL H-7) and 5 parts by weight of crystallization accelerator 1 are weighed and mixed using a KRC kneader (twin screw extruder) manufactured by KURIMOTO. Resin compositions 2 to 8 (Examples), and resin compositions 9 and 10 (Comparative Examples) were also prepared in the same manner to have the compositions shown in Table 2.

Each of the resin compositions 1 to 10 was injection-molded under the following injection conditions using a mold having a size that the molded product became a cylindrical shape of 100 mm×12 mm×4 mm. In this connection, mold temperature and holding time (cooling time) of the resin in the mold are shown in Table 2. After completion of the cooling, the mold was opened to confirm that a solidified molded product having the desired shape was obtained.

### Injection Molding Conditions

Injection molding machine used: trade name SAV-30 manufactured by SANJO SEIKI CO., LTD.
Injection pressure: 55 kg/cm²
Injection time: 5 second
Cylinder temperature 170° C.
Nozzle temperature: 180° C.

Physical properties of the thus obtained molded products were evaluated by the following evaluation methods. The results are shown in Table 2.

### (1) Tensile Strength

The tensile strength was measured by a digital control universal testing machine 5566 (manufactured by INSTRON JAPAN CO., LTD.) using No. 1 test piece in accordance with JIS K 7113.

### (2) Elongation at Rupture

The elongation at rupture was measured in accordance with JIS K 7113 using similar test piece.

### (3) IZOD Impact Strength

The IZOD impact strength was measured by an IZOD impact tester (manufactured by YASUDA SEIKI SEISAKUSHO, LTD.) in accordance with JIS K 7113 using any one of the pendulums 1 J, 2.75 J and 11 J depending on the strength of test piece.

### (4) Heat Distortion Temperature

The Heat distortion temperature was measured by an automatic heat distortion tester (manufactured by YASUDA SEIKI SEISAKUSHO, LTD.) in accordance with JIS K 7191-2 Be method using a test piece of 100 mm×12 mm×4 mm.

TABLE 1

| | | | (A):(B) | |
|---|---|---|---|---|
| | Composing | Composing | mixing ratio | Yield |
| | unit (A) | unit (B) | (mass ratio) | (%) |
| Crystallization | Corn starch | D-lactic acid | 0.3:100 | 86 |
| accelerator 1 | | | | |
| Crystallization | Glutinous rice | D-lactic acid | 0.3:100 | 76 |
| accelerator 2 | amylopectin | | | |
| Crystallization | Glucose | D-lactic acid | 0.3:100 | 88 |
| accelerator 3 | | | | |
| Crystallization | Amylose | D-lactic acid | 0.3:100 | 85 |
| accelerator 4 | (Mw = 160,000) | | | |
| Crystallization | Amylose | D-lactic acid | 0.3:100 | 84 |
| accelerator 5 | (Mw = 2,800) | | | |
| Crystallization | Pyromellitic | D-lactic acid | 0.3:100 | 88 |
| accelerator 6 | acid | | | |
| Crystallization | Starch | L-lactic acid | 0.3:100 | 73 |
| accelerator 7 | | | | |
| Crystallization | Pyrogallol | D-lactic acid | 0.3:100 | 74 |
| accelerator 8 | | | | |

Crystallization accelerators evaluation results

| | | | | | | | | | | Comparative | |
|---|---|---|---|---|---|---|---|---|---|---|---|
| | | Examples | | | | | | | | Examples | |
| | | Resin | Resin | Resin | Resin | Resin | Resin | Resin | Resin | Resin | Resin |
| | | Comp. | Comp. | Comp. | Comp. | Comp. | Comp. | Comp. | Comp. | Comp. | Comp. |
| | | 1 | 2 | 3 | 4 | 5 | 6 | 7 | 8 | 9 | 10 |
| Composition | Poly-L-Lactic acid | 100 | 100 | 100 | 100 | 100 | 100 | 100 | 100 | 100 | 100 |
| (parts by | Polylactic acid-aliphatic | 20 | 20 | 0 | 20 | 20 | 20 | 20 | 20 | — | 20 |
| weight) | polyester block copalymer | | | | | | | | | | |
| | Polycaprolactone | 5 | 5 | 5 | 5 | 5 | 5 | 5 | 5 | — | 5 |
| | Crystallization accelerator 1 | 5 | — | — | — | — | — | — | — | — | — |
| | Crystallization accelerator 2 | — | 5 | — | — | — | — | — | — | — | — |
| | Crystallization accelerator 3 | — | — | 5 | — | — | — | — | — | — | — |
| | Crystallization accelerator 4 | — | — | — | 5 | — | — | — | — | — | — |
| | Crystallization accelerator 5 | — | — | — | — | 5 | — | — | — | — | — |
| | Crystallization accelerator 6 | — | — | — | — | — | 5 | — | — | — | — |
| | Crystallization accelerator 7 | — | — | — | — | — | — | 5 | — | — | — |
| | Crystallization accelerator 8 | — | — | — | — | — | — | — | 5 | — | — |
| Physical | Mold temp (° C.) | 110 | 110 | 110 | 110 | 110 | 110 | 110 | 110 | 40 | 40 |
| | Cooling time (sec) | 2.0 | 2.0 | 2.0 | 2.0 | 2.0 | 2.0 | 2.0 | 2.0 | 0.5 | 0.5 |
| | Tensile strength (MPa) | 45 | 46 | 48 | 46 | 42 | 49 | 46 | 48 | 67 | 51 |
| | Elongation at rupture (%) | 4.1 | 3.6 | 4.0 | 3.8 | 3.8 | 4.8 | 5.0 | 4.9 | 5.8 | 5.2 |
| | IZOD impact strength (KJ/m²) | 7.2 | 6.0 | 7.3 | 6.4 | 6.0 | 7.0 | 10.1 | 7.5 | 2.7 | 7.5 |
| | Heat distortion temp. (° C.) | 112 | 119 | 129 | 129 | 130 | 120 | 66 | 122 | 53 | 53 |

As is evident from Table 2, crystallization of poly-L-lactic acid was accelerated and heat distortion temperature was sharply increased when crystallization accelerators 1 to 8 were added. Based on this, it was found that heat resistance as one of the disadvantages of polylactic acid can be improved when a resin composition is prepared by adding the crystallization accelerator of the present invention to poly-L-lactic acid.

What is claimed is:

1. A crystallization accelerator of poly-L-lactic acid, in which a composing unit (A) having a hydrophilic polar group in a molecule and a composing unit (B) having high compatibility with poly-L-lactic acid are copolymerized.

2. The crystallization accelerator according to claim 1, in which the composing unit (A) and composing unit (B) are copolymerized at a ratio of from 0.1:99.9 to 80:20 (mass ratio).

3. The crystallization accelerator according to claim 1 or 2, in which a molecule of composing unit (A) comprises two or more of hydrophilic polar groups.

4. The crystallization accelerator according to any one of claims 1 to 3, in which the hydrophilic polar group is at least one of hydroxyl and/or carboxyl.

5. The crystallization accelerator according to claim 4, in which the composing unit (A) is at least one of monosaccharides, polysaccharides and aromatic ring compounds.

6. The crystallization accelerator according to claim 5, in which the composing unit (A) is at least one of glucose, starch, amylopectin, amylose, pyromellitic acid and pyrogallol.

7. The crystallization accelerator according to any one of claims 1 to 6, in which the composing unit (B) is at least one of monomers of poly-L-lactic acid and poly-D-lactic acid and a PLLA-aliphatic polyester block copolymer and a PDLA-aliphatic polyester block copolymer.

8. A resin composition, in which from 0.5 to 50 parts by weight of the crystallization accelerator described in any one of claims 1 to 7 is blended per 100 parts by weight of poly-L-lactic acid.

9. A molded product prepared by molding the resin composition described in claim 8.

10. A method for producing a resin composition which contains poly-L lactic acid, which comprises the following (1) and (2):
(1) synthesizing a poly-L-lactic acid crystallization accelerator by copolymerizing a composing unit (A) having a hydrophilic polar group in the molecule and a composing unit (B) having high compatibility with poly-L-lactic acid, and
(2) mixing the poly-L-lactic acid crystallization accelerator synthesized in the step (1) with poly-L-lactic acid.
